(19) United States
(12) Patent Application Publication
(10) Pub. No.: US 2025/0058758 A1
(43) Pub. Date: Feb. 20, 2025

(54) ACTUATOR AND BRAKE SYSTEM INCLUDING THE SAME

(71) Applicant: HL MANDO CORPORATION, Gyeonggi-do (KR)

(72) Inventor: Daejune JUNG, Gyeonggi-do (KR)

(21) Appl. No.: 18/603,594

(22) Filed: Mar. 13, 2024

(30) Foreign Application Priority Data
Aug. 14, 2023 (KR) 10-2023-0106241

(51) Int. Cl. B60T 13/74; B60T 17/22; F16D 55/226; F16D 65/18; F16D 121/24; F16D 125/40

(52) U.S. Cl. CPC B60T 13/746; B60T 17/22; F16D 55/226; F16D 65/18; F16D 2121/24; F16D 2125/40

(57) ABSTRACT

An actuator may include: a first gear configured to rotate by a motor; a second gear operably connected to the first gear and configured to convert a rotary movement of the first gear into a linear movement; and a footer configured to move linearly together with the second gear to move a back plate of a brake pad. A stopper protrusion may be provided at one end portion of the first gear, the footer may have a stopper groove having a shape of a substantially circular arc or a partial circle such that the stopper protrusion rotating together with the first gear can be inserted in the stopper groove, and as the footer becomes closer to the one end portion of the first gear, the stopper protrusion may be inserted into the stopper groove to prevent the first gear from rotating.

### CROSS-REFERENCE TO RELATED APPLICATION(S)

This application is based on and claims priority under 35 U.S.C. § 119 to Korean Patent Application No. 10-2023-0106241, filed on Aug. 14, 2023, in the Korean Intellectual Property Office, the disclosure of which is incorporated by reference herein in its entirety.

### BACKGROUND

### 1. Field

The present disclosure generally relates to an actuator and a brake system including the same, and more particularly, to an actuator including a stopper for preventing a stuck phenomenon caused by an excessive release of an electromechanical brake, and a brake system including the actuator.

### 2. Description of the Related Art

Brake systems for brake are essential to vehicles, and various types of brake systems have been developed for the safety of drivers and passengers.

Existing brake systems have generally used a method of supplying, when a driver steps on the brake pedal, hydraulic pressure for brake to the wheel cylinder through a booster mechanically connected to the brake pedal. However, lately, an electromechanical brake system that brakes the vehicle by receiving a driver's intention to brake as an electrical signal and operating a transmission device such as a motor based on the electrical signal is being developed for drivers' convenience.

The electromechanical brake system provides a clamping force of the brake disc by receiving power from an actuator including a motor and a reducer, and performs a service brake or a parking brake of the vehicle through the clamping pressure. A ball screw device is used to convert rotation power from the motor into to linear movement to apply clamping force or pressure to the brake disc.

In a brake system using a ball screw device, when the brake pad retreats excessively, the ball nut contacts the screw shaft or the footer connected to the screw shaft in the axial direction, which may cause the stuck phenomenon. Generally, because the electromechanical brake system performs the position control of the motor by a controller, excessive retraction of the brake pad may be prevented by the controller while braking is released.

However, when the position control of the motor fails due to an error of the controller, the stuck phenomenon may occur. When the stuck phenomenon occurs, it may be difficult to release the stuck phenomenon only with the driving force of the motor. In this case, vehicle maintenance such as disassembling the brake system is needed.

### SUMMARY

An actuator according to some embodiments of the present disclosure may be capable of preventing a stuck phenomenon of a ball screw device caused by an excessive release while braking is released, and a brake system including the actuator.

An actuator according to certain embodiments of the present disclosure may be capable of using a position at which a rotation stops by a stopper as a reference point for control of a motor, and a brake system including the actuator.

Additional aspects of the disclosure will be set forth in part in the description which follows and, in part, will be obvious from the description, or may be learned by practice of the disclosure.

In accordance with an embodiment, an actuator may include: a first gear configured to rotate by receiving a rotation force from a motor; a second gear connected to the first gear on a same axis as the first gear by a ball screw method, and configured to covert a rotary motion of the first gear into a linear motion; and a footer provided at one side of the second gear, and configured to move linearly together with the second gear to press a back plate of an inner brake pad away from the first gear, wherein a stopper protrusion may be provided at one end of the first gear in such a way as to be spaced a preset distance in a radial direction from the axis, the footer may be provided with a stopper groove having a radius corresponding to a preset distance from the axis and being in a shape of a circular arc such that the stopper protrusion rotating together with the first gear is inserted in the stopper groove, and as the footer becomes close to the one end of the first gear, the stopper protrusion may be inserted into the stopper groove to prevent the first gear from rotating.

The footer may be configured to be prevented from rotating with respect to the back plate by contacting the back plate, and the second gear may be configured to be prevented from rotating with respect to the back plate by being coupled to the footer.

The footer may be provided with a rotation preventing groove in which a rotation preventing protrusion provided in the back plate is inserted.

The first gear may be a ball nut, the second gear may be a screw shaft, a flange portion protruding outward in a radial direction may be integrally provided at an outer circumference of one end of the first gear, and the stopper protrusion may protrude from the flange portion.

A protrusion height of the stopper protrusion may be greater than a pitch of the screw shaft.

A depth of the stopper groove may be greater than the protrusion height of the stopper protrusion.

The stopper groove may be in a shape of a circular arc having a central angle of 180 degrees or more.

The stopper protrusion may be configured to first contact an end of the circular arc rather than a bottom of the stopper groove as the footer becomes close to one end of the first gear.

According to an embodiment, a brake system including an inner brake pad and an outer brake pad respectively positioned at both sides of a disc may include: a motor configured to provide rotation power; a gear assembly configured to transfer rotation power of the motor; and an actuator configured to press the inner brake pad by receiving rotation power from the gear assembly, wherein the actuator may include: a first gear configured to rotate by receiving a rotation force through the gear assembly; a second gear connected to the first gear on a same axis as the first gear by a ball screw method, and configured to covert a rotary motion of the first gear into a linear motion; and a footer provided at one side of the second gear, and configured to move linearly together with the second gear to press a back plate of the inner brake pad away from the first gear, wherein a stopper protrusion may be provided at one end of the first gear in such a way as to be spaced a preset distance in a radial direction from the axis, the footer may be provided with a stopper groove having a radius corresponding to a preset distance from the axis and being in a shape of a circular arc such that the stopper protrusion is inserted in the stopper groove, and as the footer becomes close to one end of the first gear, the stopper protrusion may be inserted into the stopper groove to prevent the first gear from rotating.

The footer may be configured to be prevented from rotating with respect to the back plate by contacting the back plate, and the second gear may be configured to be prevented from rotating with respect to the back pate by being coupled to the footer.

The footer may be provided with a rotation preventing groove in which a rotation preventing protrusion provided in the back plate is inserted.

The first gear may be a ball nut, the second gear may be a screw shaft, a flange portion protruding outward in a radial direction may be integrally provided at an outer circumference of one end of the first gear, and the stopper protrusion may protrude from the flange portion.

A protrusion height of the stopper protrusion may be greater than a pitch of the screw shaft.

A depth of the stopper groove may be greater than the pitch of the screw shaft.

The brake system may further include a caliper in which the actuator is accommodated, wherein a bearing may be provided between the flange portion and the caliper.

The bearing may be a thrust bearing.

A gear portion configured to transfer rotation power by engaging with the gear assembly may be provided at another end of the first gear.

The stopper groove may be in a shape of a circular groove having a central angle of 180 degrees or more.

The stopper protrusion may be configured to first contact an end of the circular arc rather than a bottom of the stopper groove as the footer becomes close to one end of the first gear.

The brake system may further include a controller configured to control driving of the motor, wherein the controller may be configured to detect a position at which a rotation is prevented by the stopper protrusion and the stopper groove, and use the detected position as a reference position for controlling the motor.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating a brake system according to an embodiment of the present disclosure;

FIG. 2 is a cross-sectional view illustrating a portion of a brake system according to an embodiment of the present disclosure;

FIG. 3 is a perspective view illustrating an actuator according to an embodiment of the present disclosure;

FIGS. 4 and 5 are exploded perspective views of an actuator according to an embodiment of the present disclosure;

FIG. 6 is a side view of an actuator in a state in which a stopper protrusion is positioned out of a stopper groove according to an embodiment of the present disclosure;

FIG. 7 is a side view of an actuator in a state in which a stopper protrusion is inserted in a stopper groove according to an embodiment of the present disclosure;

FIG. 8 is a front view of a footer in a state in which a stopper protrusion contacts an end of a circular arc of a stopper groove according to an embodiment of the present disclosure; and

FIG. 9 is a cross-sectional view of a stopper groove in a state in which a stopper protrusion contacts an end of a circular arc of a stopper groove according to an embodiment of the present disclosure.

### DETAILED DESCRIPTION

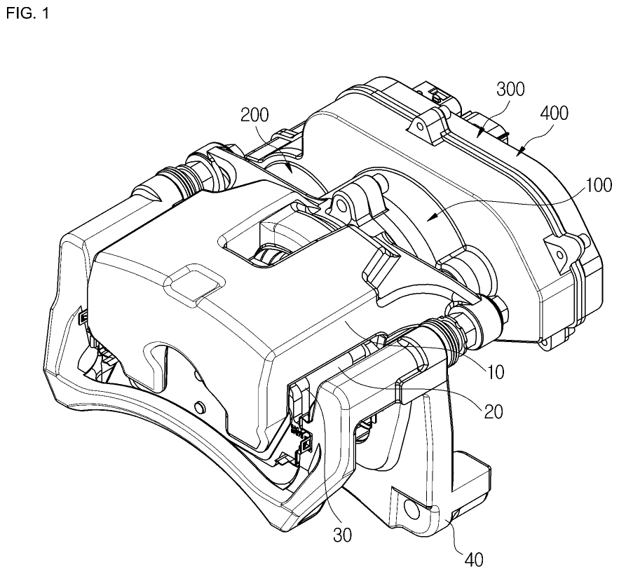

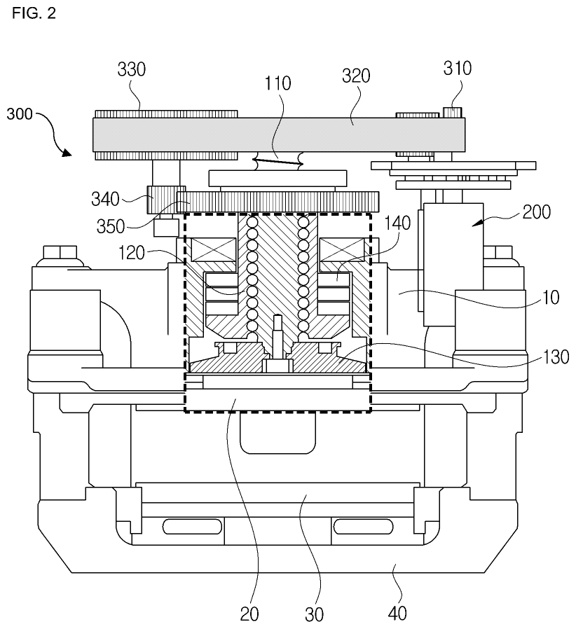

FIG. 1 is a perspective view illustrating a brake system according to an embodiment of the present disclosure, and FIG. 2 is a cross-sectional view illustrating a portion of a brake system according to an embodiment of the present disclosure.

Referring to FIGS. 1 and 2, a brake system according to an embodiment of the present disclosure may include an inner brake pad 20 and an outer brake pad 30 positioned at both sides of a disc, respectively. The brake system may further include: a motor 200 configured to generate or provide rotation force or power; a gear assembly 300 configured to transfer the rotation power of the motor 200; an actuator 100 configured to move the brake pad 200, for example, press the inner brake pad 20 in response to the rotation power received from the gear assembly 300; a caliper 10 accommodating the actuator 100 therein; and a controller 400 configured to control the motor 200.

The motor 200 may operate by receiving power from a power supply such as a battery of a vehicle, and generate and provide power for braking the vehicle. For example, the motor 200 may be accommodated in and supported by a motor accommodating portion formed by being depressed in one side of a housing, and the motor 200 may operate according to an electrical signal transferred from an Electronic Control Unit (ECU) of the controller 400. A driving gear 310 which will be described below may be coupled to a driving shaft of the motor 200, and details about the driving gear 310 will be described below.

The gear assembly 300 may reduce rotation force or power provided from the motor 200 and transfer the reduced rotation power to the actuator 100. The gear assembly 300 may include, for instance, but not limited to, a driving gear 310 provided on the driving shaft of the motor 200; a first reduction gear 330 rotatably connected with the driving gear 310 of the motor 200 and configured to transfer the rotation force or power received from the driving gear 310; a second reduction gear 340 connected to the first reduction gear 330 and configured to transfer rotation power received from the first reduction gear 330; and a third reduction gear 350 rotatably connected to or engaged with the second reduction gear 340 and configured to transfer the received rotation power to the actuator 100.

The driving gear or pulley 310 may be coupled to the driving shaft of the motor 200 and rotate together with the driving shaft by an operation or rotary force of the motor 200. The driving gear or pulley 310 may primarily reduce the rotation force or power provided from or generated by the motor 200 through a belt 320 and then transfer the reduced rotation power to the first reduction gear 330 which will be described below.

The first reduction gear 330 may receive the rotation force or power transferred from the driving gear 310 and transfer the rotation force or power to the second reduction gear 340 which will be described below. The first reduction gear 330 may be provided at one side or one end portion of a gear shaft or a connection shaft extending along an axial direction, and at the other side or the other end portion of the gear shaft or the connection shaft, the second reduction gear 340 may be provided to transfer the rotation force or power transferred from the driving gear 310 to the second reduction gear 340. A rotation axis of the gear shaft or the connection shaft may be parallel to the driving shaft of the motor 200, and the gear shaft or the connection shaft may be accommodated in the housing of the brake system.

The second reduction gear 340 may receive the rotation force or power transferred from the first reduction gear 330 and transfer the received rotation force or power to the third reduction gear 350. The second reduction gear 340 may be rotatably engaged with the third reduction gear 350 and transfer the rotation force or power to the third reduction gear 350.

The actuator 100 may receive the rotation force or power from the gear assembly 300 and be configured to move the inner brake pad 20 in response to the rotation force or power from the gear assembly 300, for instance, press the inner brake pad 20. For example, the actuator 100 may be accommodated in the caliper 10. The inner brake pad 20 and the outer brake pad 30 may be respectively positioned on or at both sides of the brake disc, and while the inner brake pad 20 is pressed or moved by the actuator 100, a finger portion of the caliper 10 may press or move the outer brake pad 30 by a reaction force. Accordingly, the inner brake pad 20 and the outer brake pad 30 may press or clamp the brake disc at the both sides, respectively, so that the braking may be performed by friction.

The actuator 100 may include: a first gear (or a rotatable part) 120 configured to be rotatable by performing a rotary motion according to the rotation force or power received through the gear assembly 300; a second gear (or a translatable part) 110 operably connected to the first gear 120, arranged coaxially with the first gear 120 on the same axis as the first gear 120 by, for instance, but not limited to, a ball screw mechanism or method, and configured to be translatable by converting a rotary motion of the first gear 120 into a linear motion; and a footer or footing 130 provided at one side of the second gear 110 or coupled to an end portion of the second gear 110 and configured to move linearly together with the second gear (or the translatable part) 110 to press a back plate 22 of the inner brake pad 20 in a direction away from the first gear 120.

In an exemplary embodiment of the present disclosure, the first gear 120 may be a ball nut, and the second gear 110 may be a screw shaft, although not required. The ball nut may be connected to the screw shaft by the ball screw mechanism or method, and while the ball nut rotates, the rotation of the ball nut causes the screw shaft of which rotation is blocked to move linearly.

For example, according to an embodiment of the present disclosure, the footer or footing 130 cannot rotate or may be prevented from rotating with respect to the back plate 22 by contacting the back plate 22 of the inner brake pad 20, and the second gear (or the translatable part) 110 may cannot rotate or may be prevented from rotating with respect to the back plate 22 by being coupled to the footer or footing 130. As such, in a state in which the axial rotation of the second gear 110 is blocked, the motor 200 may provide rotation force or power to the first gear (or the rotatable part) 120 operably connected to the second gear (or the translatable part) 110 by the ball screw mechanism or method to linearly move the second gear (or the translatable part) 110.

Alternatively, according to another embodiment of the present disclosure, the first gear (or the rotatable part) 120 may be a screw shaft, and the second gear (or the translatable part) 110 may be a ball nut. The ball nut may be connected to the screw shaft by the ball screw mechanism or method, and while the screw shaft rotates, the rotation of the screw shaft causes the ball nut of which rotation is blocked to move linearly.

Hereinafter, the actuator 100 according to an embodiment of the present disclosure will be described in more detail.

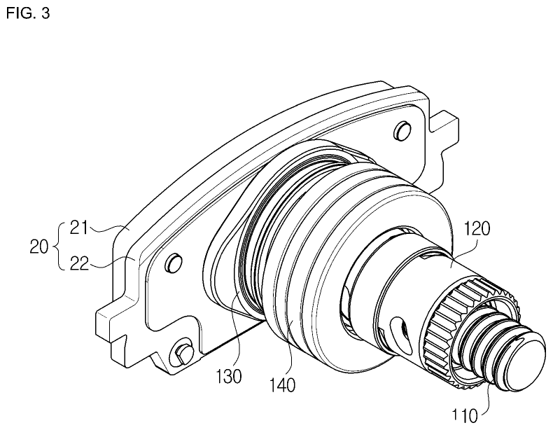

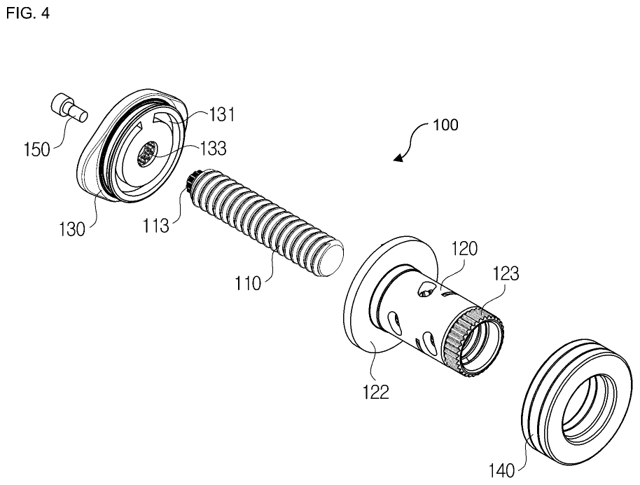

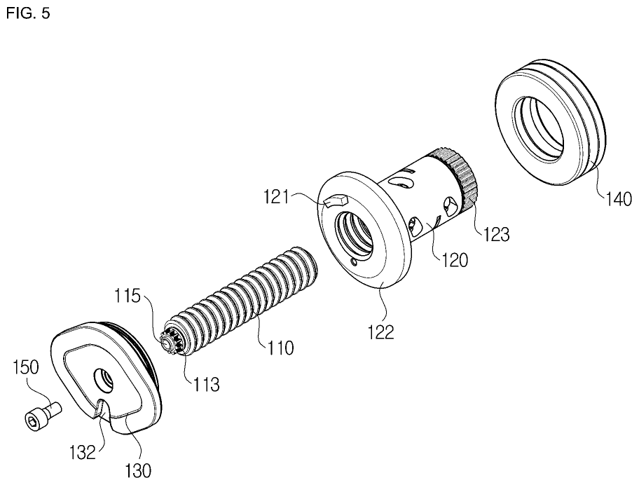

FIG. 3 is a perspective view illustrating an actuator according to an embodiment of the present disclosure, and FIGS. 4 and 5 are exploded perspective views of an actuator according to an embodiment of the present disclosure.

Referring to FIGS. 3 to 5, the footer or footing 130 may be directly or indirectly coupled to or in contact with the back plate 22 of the inner brake pad 20, the second gear (or the translatable part) 110 may be coupled to the footer or footing 130 by, for example, but not limited to, a coupling screw 150. For instance, first gear (or the rotatable part) 120 may be connected to the second gear (or translatable part) 110 by the ball screw mechanism or method.

The footer or footing 130 may include a rotation preventing groove 132 in which a rotation preventing protrusion provided in the back plate 22 is inserted so that the footer or footing 130 cannot rotate. When the footer 130 contacts the back plate 22, the rotation preventing protrusion of the back plate 22 may be inserted into the rotation preventing groove 132, thereby preventing the footer or footing 130 from rotating.

The footer or footing 130 may be coupled to the second gear (or the translatable part) 110 by the coupling screw 150. The coupling screw 150 may be screwed or inserted in a screw coupling hole 115 provided in an end of the second gear (or the translatable part) 110 by penetrating the footer 130 to couple the footer or footing 130 to the second gear (or the translatable part) 110.

In this example, a rotation preventing coupler 113 may be provided at the end of the second gear (or the translatable part) 110. The rotation preventing coupler 113 may have, for example, but not limited to, a polygon shape, preferably, a gear tooth shape. The rotation preventing coupler 113 may be inserted in a rotation preventing coupling groove 133 provided on the footer 130. The rotation preventing coupling groove 133 may be provided as a groove having a shape corresponding to, or capable of being fixedly coupled with, the shape of the rotation preventing coupler 113 to prevent the rotary movement of the second gear (or translatable part) 110 upon the insertion of the rotation preventing coupler 113.

At an outer circumference of one end portion of the first gear (or the rotatable part) 120, a flange portion 122 protruding outward in a radial direction may be integrally provided. And, at the other end of the first gear (or the rotatable part) 120, a gear portion 123 rotatably engaged with the gear assembly 300 to transfer the rotation force or power may be provided. The gear portion 123 may cause the first gear (or the rotatable part) 120 to rotate by being rotatably engaged with the third reduction gear 350 of the gear assembly 300 to receive the rotation force or power.

Meanwhile, a bearing 140 may be provided between the first gear (or the rotatable part) 120 and the caliper 10 (or any non-rotatable structure of the vehicle) to rotatably support the first gear (or the rotatable) 120. For instance, the bearing 140 may be positioned between the flange portion 122 and the caliper 10, and the bearing 140 may be a thrust bearing. If the bearing 140 is a thrust bearing positioned between the flange portion 122 and the caliper 10, the first gear (or the rotatable part) 120 may easily rotate inside the caliper 10 regardless of a reactive force transferred while the footer or footing 130 presses the inner brake pad 20 by the linear movement of the second gear (or the translatable part) 110.

Referring to FIG. 5, a stopper protrusion 121 may be provided at one end portion of the first gear (or the rotatable part) 120 in such a way as to be spaced apart from the rotation axis in the radial direction from the axis. The stopper protrusion 121 may protrude from the flange portion 122.

Also, referring to FIG. 4, the footer or footing 130 may be provided with a stopper groove 131 having a radius corresponding to a preset distance from the axis. For example, the stopper groove 131 of the footer or footing 130 is in a shape of a circular arc or a partial circle such that the stopper protrusion 121 is inserted in the stopper groove 131.

The second gear (or the translatable part) 110 may move linearly along the axial direction by the rotation of the first gear 120, and the footer of the footing 130 fixedly coupled to the second gear (or the translatable part) 110 may move linearly along the axial direction together with the second gear (or the translatable part) 110. As the footer or footing 130 moves closer to one end of the first gear (or the rotatable part) 120, the stopper protrusion 121 of the first gear (or the rotatable part) 120 may be inserted into the stopper groove 133 of the footer or footing 130 to prevent the first gear (or the rotatable part) 120 from rotating.

The stopper groove 121 may thee in the shape of a circular arc or a partial circle, as shown in FIG. 4. Because the stopper groove 131 is in the shape of the circular arc or the partial circle, the stopper protrusion 121 rotating according to the rotation of the first gear (or the rotatable part) 120 may be rotatable within to a preset angle range in a state of being inserted into the stopper groove 131, and while the stopper protrusion 121 contacts an end of the circular arc or the partial circle of the stopper groove 131, the first gear 120 may be prevented from rotating.

Meanwhile, in the exemplary embodiment shown in FIGS. 3 to 5, the stopper groove 133 is provided in or on the footer 130, and the stopper protrusion 121 may be provided in or on the first gear (or the rotatable part) 120, although not required. Alternatively, the stopper protrusion 121 may be provided in or on the footer or footing 130, and the stopper groove 133 may be provided in or on the first gear (or the rotatable part) 120.

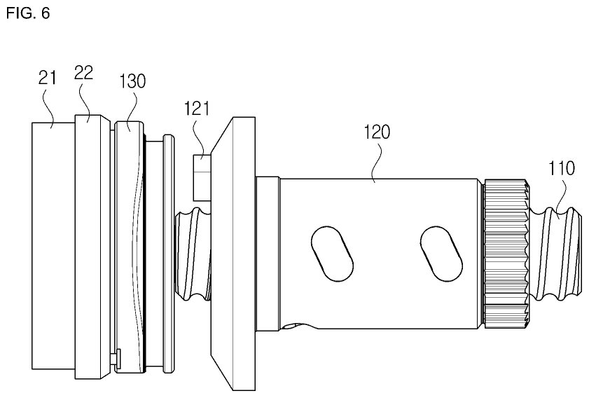

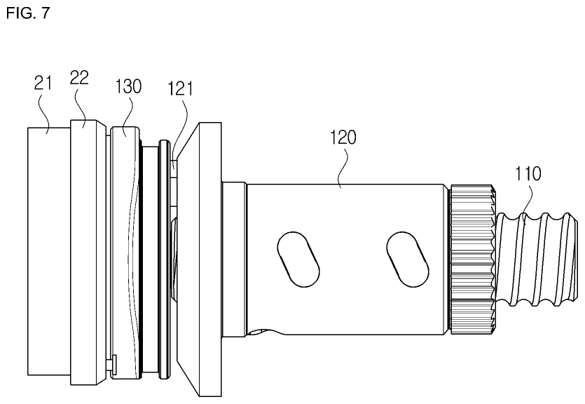

FIG. 6 is a side view of an actuator in a state in which a stopper protrusion is positioned out of a stopper groove according to an embodiment of the present disclosure, and FIG. 7 is a side view of an actuator in a state in which a stopper protrusion is inserted in a stopper groove according to an embodiment of the present disclosure.

The footer or footing 130 fixedly coupled to the second gear (or the translatable part) 110 configured to be movable linearly in response to the rotation of the first gear (or the rotatable part) 120 may move linearly by the rotation of the first gear 120. Referring to FIG. 6, the footer 130 may be spaced apart from one end of the first gear (or the rotatable part) 120. Accordingly, because the stopper protrusion 121 is positioned out of the stopper groove 131 of the footer 130, the first gear (or the rotatable part) 120 may rotate freely without any limitation of a rotatable range, and the footer 130 may move linearly according to the rotation of the first gear (or the rotatable part) 120 to press the back plate 22 of the brake pad 20. As such, the footer 130 may press the back plate 22, and thereby, a frictional material 21 of the brake pad 20 may contact the brake disc to perform the braking.

Meanwhile, as shown in FIG. 7, while the footer 130 further linearly moves toward the first gear (or the rotatable part) 120 by the rotation of the first gear (or the rotatable part) 120, the stopper protrusion 121 of the first gear 120 may be inserted into the stopper groove 131 of the footer 130. Then, the stopper protrusion 121 may contact an end of the circular arc or the partial circle of the stopper groove 131, and this may cause the first gear (or the rotatable part) 120 to be prevented from further rotating. Accordingly, the footer 130 may not directly contact the first gear (or the rotatable part) 120 in the axial direction, and a stuck phenomenon that is caused by an axial contact may be prevented.

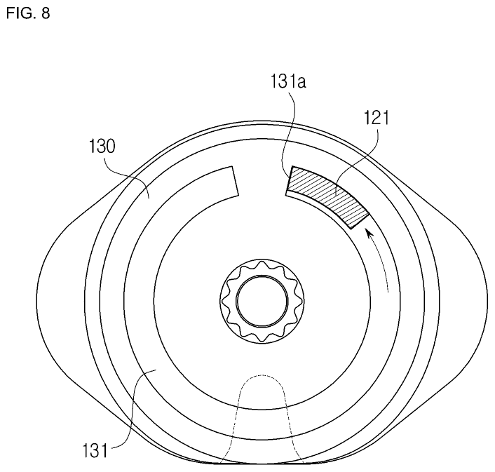

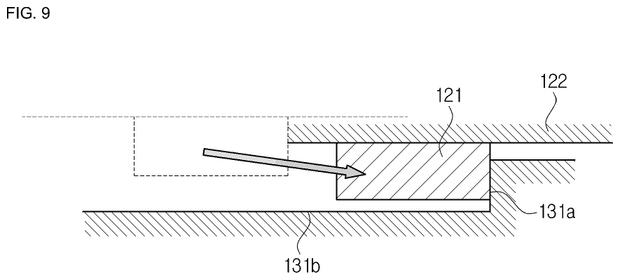

FIG. 8 is a front view of a footer in a state in which a stopper protrusion contacts an end of a circular arc of a stopper groove according to an embodiment of the present disclosure, and FIG. 9 is a cross-sectional view of a stopper groove in a state in which a stopper protrusion contacts an end of a circular arc of a stopper groove according to an embodiment of the present disclosure.

FIG. 8 shows a state in which the stopper protrusion 121 which is inserted in the stopper groove 131 having the shape of the circular arc contacts an end 131a of the circular arc or the partial circle of the stopper groove 131.

As shown in FIG. 8, the stopper groove 131 may be in a shape of a circular arc or a partial circle having a central angle of 180 degrees or more. More preferably, the stopper groove 131 may be in a shape of a circular arc or a partial circle having a central angle of 270 degrees or more to limit the rotatable angle of the first gear (or the rotatable part) 120 in order to prevent contact between the footer or footing 130 and the first gear (or the rotatable part) 120. The stopper protrusion 121 may rotate together with the first gear (or the rotatable part) 120, and as the footer 130 becomes gradually closer to the stopper protrusion 121 by the rotation of the first gear (or the rotatable part) 120, the stopper protrusion 121 may be inserted into the stopper groove 131 while rotating. The stopper groove 131 may be in a shape of a circular arc or a partial circle having a central angle of 180 degrees or more, preferably 270 degrees or more, such that the stopper protrusion 121 is inserted into the stopper groove 131 while rotating to a preset angle or more.

Meanwhile, referring to FIG. 9, according to an embodiment of the present disclosure, as the footer 130 becomes closer to one end of the first gear (or the rotatable part) 120, the stopper protrusion 121 may contact the end 131a of the circular arc or the partial circle of the stopper groove 131 rather than a bottom 131b of the stopper groove 131.

Even when the footer 130 becomes closer to the first gear 120, the stopper protrusion 121 and the stopper groove 131 may configured not to allow the footer 130 to be directly contacted with the first gear (or the rotatable part) 120 in the axial direction to prevent the stuck phenomenon. For this end, the stopper protrusion 121 may contact the stopper groove 131 before the footer 130 contacts the first gear (or the rotatable part) 120 to prevent the end of the first gear 120 from directly contacting the footer 130 in the axial direction, and the stopper protrusion 121 may contact the end 131a of the circular arc or the partial circle rather than the bottom 131b of the stopper groove 131 to prevent the first gear (or the rotatable part) 120 from directly contacting the footer 130 in the axial direction.

For instance, a protrusion height of the stopper protrusion 121 may be greater than a pitch of the second gear (or the translatable part) 110 implemented as a screw shaft.

Because the first gear (or the translatable part) 120 and the second gear (or the rotatable part) 110 are coupled by the ball screw mechanism or method, the second gear (or the translatable part) 110 may linearly move by the pitch of the screw shaft when the first gear (or the rotatable part) 120 rotates one revolution. A difference between a distance between the footer 130 and the end of the first gear (or the rotatable part) 120 after the first gear (or the rotatable part) 120 rotates one revolution (see FIG. 7) and a distance between the footer 130 and the end of the first gear (or the rotatable part) 120 before the stopper protrusion 121 is inserted in the stopper groove 131 (see FIG. 6) may be the pitch of the screw shaft. If the protrusion height of the stopper protrusion 121 is smaller than the pitch of the second gear (or the translatable part) 110, while the stopper protrusion 121 is inserted into the stopper groove 131, the footer 130 may directly contact the end of the first gear 120 before the stopper protrusion 121 contacts the end 131a of the circular arc of the stopper groove 131, which may cause a stuck phenomenon. Therefore, according to an embodiment of the present disclosure, the protrusion height of the stopper protrusion 121 may be greater than the pitch of the second gear (or the translatable part) 110 implemented as a screw shaft to prevent the footer 130 from directly contacting the end of the first gear (or the rotatable part) 120.

According to an embodiment of the present disclosure, a depth of the stopper groove 131 may be greater than the pitch of the second gear (or the translatable part) 110 implemented as a screw shaft.

As described above, the second gear (or the translatable part) 110 may move by the pitch of the screw shaft each time when the first gear (or the rotatable part) 120 rotates one revolution. And, each time when the first gear (or the rotatable part) 120 rotates one revolution, the footer 130 may also move by the pitch of the screw shaft. That is, a difference between a distance between the bottom 131b of the stopper groove 121 and an end of the stopper protrusion 121 after the first gear (or the rotatable part) 120 rotates one revolution (see FIG. 7) and a distance between the bottom 131b of the stopper groove 131 and the end of the stopper protrusion 121 before the stopper protrusion 121 is inserted in the stopper groove 131 (see FIG. 6) may be the pitch of the screw shaft. If the depth of the stopper groove 131 is smaller than the pitch of the second gear (or the translatable part) 110, the end of the stopper protrusion 121 may contact the bottom surface 131b rather than the end 131a of the circular arc or the partial circle of the stopper groove 131, which may cause a stuck phenomenon. According to an embodiment of the present disclosure, because the depth of the stopper groove 131 is greater than the pitch of the second gear (or the translatable part) 110 implemented as a screw shaft, the stopper protrusion 121 may contact the end 131a of the circular arc or the partial circle of the stopper groove 131 rather than the bottom 121b of the stopper groove 131 to prevent the first gear 120 from rotating, and therefore the end of the stopper protrusion 121 cannot directly contact the bottom 131b of the stopper groove 131.

The brake system according to an embodiment may include the controller 400. The controller 400 may control operations of the braking of the brake system by controlling the motor 200. The controller 400 may be configured as a circuit including devices or electric components mounted on a Printed Circuit Board (PCB), and provided inside the housing of the brake system (see FIG. 1).

The controller 400 may be connected to a motor position sensor configured to detect a rotation position of the motor 200 to control the rotation of the motor 200 to control the rotation of the first gear (or the rotatable part) 120 and control the press or release movement of the brake pads 20 and 30. However, upon a failure or malfunction in the controller 400 or the sensor or the occurrence of error such as accumulation of errors, the controller 400 may fail to properly control the motor 200 and the first gear (or the rotatable part) 120.

The controller 400 according to an embodiment of the present disclosure may detect a position at which a rotation of the first gear (or the rotatable part) 120 is prevented by the stopper protrusion 121 and the stopper groove 131, and use the detected position as a reference position for controlling the motor 200.

While, during the rotation of the first gear (or the rotatable part) 120, for instance, during a reverse rotation for releasing the pressure applied to the brake pads 20 and 30, the stopper protrusion 121 is inserted into the stopper groove 131 to prevent the first gear (or the rotatable part) 120 from rotating, and a load applied to the motor 200 may increase abruptly. At this time, the controller 400 may detect rotation prevention by the stopper protrusion 121 and the stopper groove 131 through a device, for example, a sensor such as a motor current sensor or a motor voltage sensor.

The controller 400 may detect a position at which a rotation of the first gear (or the rotatable part) 120 is prevented by the stopper protrusion 121 and the stopper groove 131, and use the detected position as a reference position for controlling the motor 200. For example, the controller 400 may set a position at which a rotation of the first gear (or the rotatable part) 120 is prevented by the stopper protrusion 121 and the stopper groove 131 to an origin or reference point, increase a value of the position as the motor 200 rotates in a direction for pressing the brake pads 20 and 30 in a forward direction, and control the motor 200 based on the value of the position. As such, by using a position at which a rotation is prevented by the stopper protrusion 121 and the stopper groove 131 as a reference position for controlling the motor 200, the control stability of the motor 200 may be improved.

The actuator and the brake system including the same according to some embodiments of the present disclosure may prevent the stuck phenomenon of the ball screw device that is caused by an excessive release while performing the release of the brake.

The actuator and the brake system including the same according to certain embodiments of the present disclosure may use a position at which a rotation of a rotatable part of the actuator stops by the stopper as a reference point for position control.

What is claimed is:

1. An actuator comprising:
a first gear configured to be rotatable by a rotation force of a motor;
a second gear arranged coaxially with the first gear and configured to be translatable by converting a rotary movement of the first gear into a linear movement; and
a footer coupled to the second gear and configured to move linearly together with the second gear to move a back plate of a brake pad,
wherein:
a stopper protrusion is provided at one end portion of the first gear and positioned at a distance away from a rotation axis of the first gear, and
the footer has a stopper groove having a shape of a substantially circular arc or a partial circle with a radius corresponding to the distance of the stopper protrusion away from the rotation axis of the first gear such that the stopper protrusion rotating together with the first gear is insertable into the stopper groove of the footer according to rotation of the first gear and an end portion of the stopper groove of the footer is configured to limit the rotation of the first gear.

2. The actuator of claim 2, wherein:
the footer is fixedly coupled to the back plate to limit rotation of the footer with respect to the back plate, and
the second gear is fixedly coupled to the footer to limit rotation of the second gear with respect to the back plate.

3. The actuator of claim 2, wherein the footer has a rotation preventing groove in which a rotation preventing protrusion of the back plate is inserted.

4. The actuator of claim 1, wherein:
the first gear has a ball nut,
the second gear has a screw shaft, and
the stopper protrusion protrudes from a flange portion which protrudes outward in a radial direction from one end portion of the first gear.

5. The actuator of claim 4, wherein a protrusion height of the stopper protrusion protruding from the flange portion of the first gear is greater than a pitch of the screw shaft of the second gear.

6. The actuator of claim 5, wherein a depth of the stopper groove of the footer is greater than the protrusion height of the stopper protrusion protruding from the flange portion of the first gear.

7. The actuator of claim 1, wherein a central angle of the stopper groove of the footer having the substantially circular arc or the partial circle is equal to or greater than 180 degrees.

8. The actuator of claim 1, wherein the stopper protrusion protruding from the flange portion of the first gear is configured to be contactable with an end of the stopper groove not to contact a bottom of the stopper groove as the footer becomes close to one end of the first gear.

9. A brake system comprising:
a motor configured to provide rotation power;
a gear assembly configured to transfer the rotation power of the motor; and
an actuator configured to move a brake pad according to the rotation power from the gear assembly,
wherein the actuator comprises:
a first gear configured to be rotatable by the rotation power received through the gear assembly;
a second gear arranged coaxially with the first gear and configured to be translatable by converting a rotary movement of the first gear into a linear movement; and
a footer coupled to the second gear and configured to move linearly together with the second gear to move a back plate of the brake pad,
wherein a stopper protrusion is provided at one end portion of the first gear and positioned at a distance away from a rotation axis of the first gear, and
the footer is provided with a stopper groove having a shape of a substantially circular arc or a partial circle with a radius corresponding to the distance of the stopper protrusion away from the rotation axis of the first gear such that the stopper protrusion is insertable into the stopper groove of the footer according to rotation of the first gear and an end portion of the stopper groove of the footer is configured to limit the rotation of the first gear.

10. The brake system of claim 9, wherein:
the footer is fixedly coupled to the back plate to limit rotation of the footer with respect to the back plate, and
the second gear is fixedly coupled to the footer to limit rotation of the second gear with respect to the back pate.

11. The brake system of claim 10, wherein the footer has a rotation preventing groove in which a rotation preventing protrusion of the back plate is inserted.

12. The brake system of claim 9, wherein:
the first gear has a ball nut,
the second gear has a screw shaft, and
the stopper protrusion protrudes from a flange portion which protrudes outward in a radial direction from one end portion of the first gear.

13. The brake system of claim 12, wherein a protrusion height of the stopper protrusion protruding from the flange portion of the first gear is greater than a pitch of the screw shaft of the second gear.

14. The brake system of claim 13, wherein a depth of the stopper groove of the footer is greater than the pitch of the screw shaft of the second gear.

15. The brake system of claim 12, further comprising:
a caliper accommodating the actuator therein; and
a bearing disposed between the caliper and the flange portion protruding from the flange portion of the first gear.

16. The brake system of claim 15, wherein the bearing is a thrust bearing.

17. The brake system of claim 12, wherein the first gear has a gear portion rotatably engaged with the gear assembly.

18. The brake system of claim 9, wherein a central angle of the stopper groove of the footer having the substantially circular arc or the partial circle is equal to or greater than 180 degrees.

19. The brake system of claim 9, wherein the stopper protrusion protruding from the flange portion of the first gear is configured to be contactable with an end of the stopper groove not to contact a bottom of the stopper groove as the footer becomes close to one end of the first gear.

20. The brake system of claim 9, further comprising a controller configured to control the motor,
wherein the controller is configured to detect a position at which rotation of the first gear is stopped by the stopper protrusion of the first gear and the stopper groove of the footer and set the detected position as a reference position for controlling the motor.
